(19) United States
(12) Patent Application Publication
(10) Pub. No.: US 2018/0189004 A1
(43) Pub. Date: Jul. 5, 2018

(54) PRINT JOB TICKET MANAGEMENT

(71) Applicant: Konica Minolta Laboratory U.S.A., Inc., San Mateo, CA (US)

(72) Inventor: Ryoichi Yokoohji, San Mateo, CA (US)

(73) Assignee: Konica Minolta Laboratory U.S.A., Inc., San Mateo, CA (US)

(21) Appl. No.: 15/395,888

(22) Filed: Dec. 30, 2016

(51) Int. Cl. G06F 3/12; G06K 15/02; G06K 15/00

(52) U.S. Cl. CPC G06F 3/1206; G06F 3/1205; G06K 15/403; G06K 15/1802; G06F 3/1275

(57) ABSTRACT

A method for printing. The method includes: receiving, by a print manager executing on a computer processor, a user print job ticket including a normal-type print parameter and a first user value for the normal-type print parameter; identifying, within a print job dictionary, a first mapping object for the normal-type print parameter; determining, by the print manager and from the first mapping object, a first native print parameter corresponding to the normal-type print parameter; determining, by the print manager and from the first mapping object, a first native value corresponding to the first user value; generating, by the print manager, a native print job ticket including the first native print parameter and the first native value for the first native print parameter; and generating a hardcopy based on the native print job ticket by sending the native print job ticket to a printer.

### BACKGROUND

A print job ticket has instructions for printing one or more print jobs. These instructions may correspond, for example, to the number of copies, stapling, two-sided printing, etc. Different users often issue print job tickets in different formats (e.g., with different parameter names). Accordingly, a print management software application with multiple users must be coded to handle the different formats of the different users.

If an existing user changes a format and/or if there is a new user, the code of the print management software application must be revised to handle the changed/new format. This takes considerable time and expense. Regardless, users still wish to issue print job tickets in custom formats.

### SUMMARY

In general, in one aspect, the invention relates to a method for printing. The method comprises: receiving, by a print manager executing on a computer processor, a user print job ticket comprising a normal-type print parameter and a first user value for the normal-type print parameter; identifying, within a print job dictionary, a first mapping object for the normal-type print parameter; determining, by the print manager and from the first mapping object, a first native print parameter corresponding to the normal-type print parameter; determining, by the print manager and from the first mapping object, a first native value corresponding to the first user value; generating, by the print manager, a native print job ticket comprising the first native print parameter and the first native value for the first native print parameter; and generating a hardcopy based on the native print job ticket by sending the native print job ticket to a printer.

In general, in one aspect, the invention relates to a non-transitory computer readable medium (CRM) storing computer program code. The computer program code, when executed by a computer processor: receives a user print job ticket and comprising a normal-type print parameter and a first user value for the normal-type print parameter; identifies, within a print job dictionary, a first mapping object for the normal-type print parameter; determines, from the first mapping object, a first native print parameter corresponding to the normal-type print parameter; determines, from the first mapping object, a first native value corresponding to the first user value; generates a native print job ticket comprising the first native print parameter and the first native value for the first native print parameter; and generates a hardcopy based on native print job ticket by sending the native print job ticket to a printer.

In general, in one aspect, the invention relates to a system for printing. The system comprises: a memory; a computer processor that: receives a user print job ticket and comprising a normal-type print parameter and a first user value for the normal-type print parameter; identifies, within a print job dictionary, a first mapping object for the normal-type print parameter; determines, from the first mapping object, a first native print parameter corresponding to the normal-type print parameter; determines, from the first mapping object, a first native value corresponding to the first user value; and generates a native print job ticket comprising the first native print parameter and the first native value for the first native print parameter; and a printer that generates a hardcopy based on the native print job ticket.

Other aspects of the invention will be apparent from the following description and the appended claims.

### BRIEF DESCRIPTION OF DRAWINGS

FIG. 1 shows a system in accordance with one or more embodiments of the invention.

FIG. 2 and FIG. 3 show flowcharts in accordance with one or more embodiments of the invention.

FIG. 4A-4D show examples in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide for a method, a system, and a non-transitory computer readable medium (CRM) for printing. Specifically, a native print job ticket is generated for each user print job ticket that is received. The user print job ticket includes user print parameters and user values for the user print parameters. Generating the native print job ticket includes accessing a print job dictionary to determine one or more native print parameters and one or more native values that correspond to each user print parameter and user value in the user print job ticket. The native print job ticket is sent to a printer and includes the determined native print parameters and the determined native values, but not the user print parameters. The print job dictionary may be updated if the user changes the format (e.g., names) of the user print parameters. Similarly, additional print job dictionaries may be created, by way of GUI windows, from sample print job tickets issued by new users.

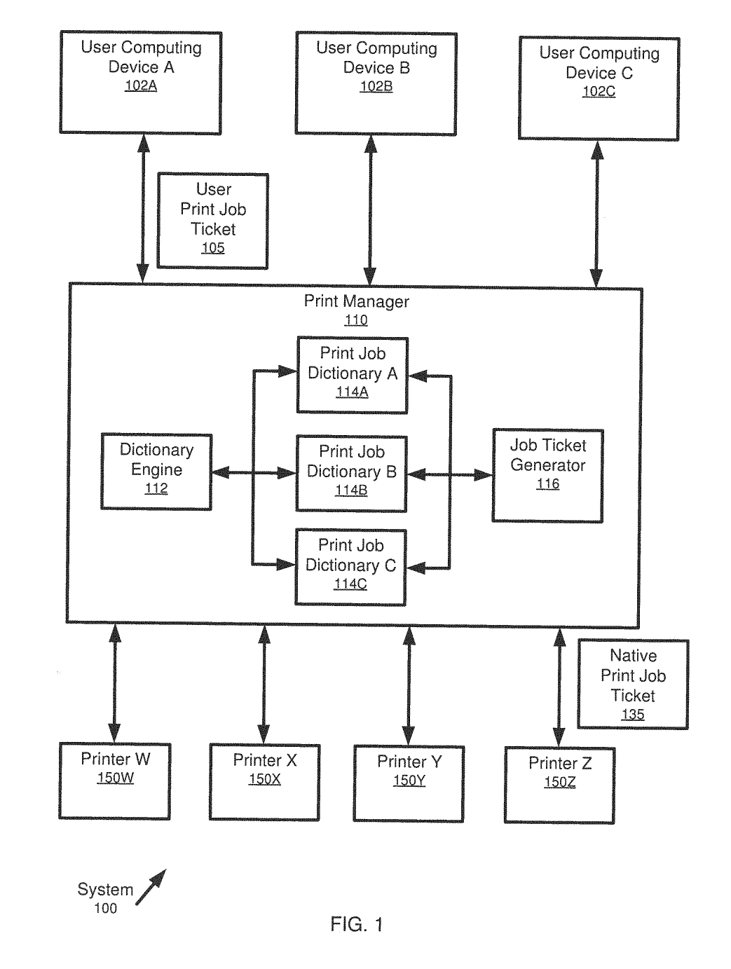

FIG. 1 shows a system (100) in accordance with one or more embodiments of the invention. As shown in FIG. 1, the system (100) includes multiple user computing devices (i.e., User Computing Device A (102A), User Computing Device B (102B), User Computing Device C (102C)). Each user computing device (102A-102C) may correspond to a personal computer (PC), a laptop, a mobile computing device (e.g., tablet PC, smartphone, etc.), a server, a mainframe, a kiosk, etc. As also shown in FIG. 1, the system (100) includes multiple printers (i.e., Printer W (150W), Printer X (150X), Printer Y (150Y), and Printer Z (150Z)). The user computing devices (102A-102C) and the printers (150W-150Z) are connected to a print manager (110) by one or more networks of any size having wired and/or wireless segments.

In one or more embodiments of the invention, each user computing device (102A-102C) is operated by a different user (e.g., individual, company, etc.) and is configured to issue print job tickets in a format specific to the user. Accordingly, print job tickets issued by different users may have different parameter names for the same print setting/feature (e.g., number of copies, stapling, two-sided printing, etc.). Example formats include XML, JDF, JSON, CSV, etc., and even these formats may be customized between users. As shown in FIG. 1, user computing device A (102A) has issued a user print job ticket (105).

In one or more embodiments of the invention, the user print job ticket (105) includes multiple user print parameters and a user value for each of the user print parameters. The user print parameters and the user values form instructions for printing one or more print jobs (e.g., number of copies, stapling, two-sided printing, etc.). However, as the names of the print parameters might be specific to the format of user computing device A (102A), the printers (150W-150Z) might not be able to interpret/execute the instructions in the user print job ticket (105), and thus might not correctly print one or more print jobs.

In one or more embodiments, the system (100) includes the print manager (110). The print manager (110) may be implemented in hardware (i.e., circuitry), software, or any combination of hardware and software. The print manager (110) is configured to generate a native print job ticket for each received user print job ticket. For example, the print manager (110) generates the native print job ticket (135) based on the user print job ticket (105). The native print job ticket (135) includes native print parameters and native values for the native print parameters. These native print parameters and native values can be successfully interpreted/executed by the printers (150W-150Z), resulting in correctly printed print jobs.

In one or more embodiments, each user print parameter in the user print job ticket (105) is classified as a simple-type print parameter, a normal-type print parameter, or a complex-type print parameter. A complex-type print parameter is replaced with multiple native print parameters in the native print job ticket (135). Additionally or alternatively, multiple complex-type print parameters are replaced with a single native print parameter. Additionally or alternatively, multiple complex-type print parameters are replaced with multiple native print parameters.

In contrast, each of a normal-type print parameter and a simple-type print parameter is replaced with a single native print parameter in the native print job ticket (105). In one or more embodiments of the invention, the user value for a simple-type print parameter, as specified in the user print job ticket (105), is included in the native print job ticket (135). In contrast, the user values for a normal-type print parameter and a complex-type print parameter in the user print job ticket (105) are mapped to native values, and these native values are included in the native print job ticket (135).

In one or more embodiment of the invention, the print manager (110) includes multiple print job dictionaries (i.e., Print Job Dictionary A (114A), Print Job Dictionary B (114B), Print Job Dictionary C (114C)). As discussed above, each user computing device (102A-102C) issues print job tickets in a custom format. Accordingly, there is one print job dictionary (114A-114C) for each user computing device (102A-102C) (i.e., one print job dictionary for each format). A print job dictionary (102A-102C) includes multiple mapping objects. In one or more embodiments of the invention, there is one mapping object for each possible user print parameter that may be found in a print job ticket issued by the user computing device. For example, print job dictionary A (114A) corresponds to user computing device A (102A). Accordingly, print job dictionary A (114A) includes a mapping object for each user print parameter that might be found in a print job ticket issued by user computing device A (102A).

As discussed above, each user print parameter found in a user print job ticket may correspond to a native print parameter. Moreover, a user value for the user print parameter may be mapped to a native value for the native print parameter. In one or more embodiments of the invention, the mapping object for a user print parameter specifies the one or more native print parameters corresponding to the user print parameter. Further, the mapping object for the user print parameter also provides the mapping between a user value for the user print parameter and a native value for the corresponding native print parameter.

In one or more embodiments of the invention, the print manager (110) includes the dictionary engine (112). The dictionary engine (112) is configured to generate a print job dictionary (114A-114C). In one or more embodiments of the invention, the dictionary engine (112) displays, within a main GUI window, a table with at least some of the native print parameters. The dictionary engine (112) may also display, within the main GUI window, a list of user print parameters extracted from one or more sample user print job tickets. An operator may drag a user print parameter from the list and drop it in the table next to the corresponding native print parameter. If the user print parameter corresponds to multiple native print parameters, the operator may drop the user print parameter next to one of the corresponding native print parameters, and then augment the table (discussed below) to include the additional corresponding native print parameters adjacent to the dropped user print parameter. It is through these drag-drop and augment operations that the table is populated and that relationships between each user print parameter and one or more corresponding native print parameters are formed. The table may be stored in any format (e.g., XML format).

In one or more embodiments of the invention, the dictionary engine (112) also enables the operator to specify, within an auxiliary GUI window, the mappings between a user value for a user print parameter and a native value for the corresponding native print parameter. As discussed above, a user print parameter may be classified as a simple-type print parameter, a normal-type print parameter, and a complex-type print parameter. In a simple-type print parameter, the native value (for the native print parameter) equals the user value. In normal-type or complex-type print parameters, the native value (for the native print parameter) is usually different from the user value.

In one or more embodiments of the invention, the dictionary engine (112) generates a print job dictionary with mapping objects from the populated table and mappings. Further, although FIG. 1 shows the dictionary engine (112) being internal to the print manager (110), in one or more embodiments, the dictionary engine (112) is external to and independent from the print manager (110). In other words, in some embodiments, an entity completely different from the print manager (110) may operate the dictionary engine (112).

In one or more embodiments of the invention, the job ticket generator (116) is configured to generate a native print job ticket based on a user print job ticket. For example, the job ticket generator (116) generates the native print job ticket (135) based on the user print job ticket (105). Generating the native print job ticket (135) includes accessing print job dictionary A (114A), and for each user print parameter in the user print job ticket, determining the one or more corresponding native print parameters from the mapping object (in print job dictionary A (114A)) for the user print parameter. The user print job ticket also includes a user value for each user print parameter. Generating the native print job ticket also includes determining, from the mapping object, the native value that maps to the user value. The native print job ticket includes the determined native print parameters and determined native values for the native print parameters. However, the user print parameters are excluded from (i.e., not included in) the native print job ticket. As discussed above, the native print parameters and determined native values form instructions that can be interpreted/executed by the printers (150W-150Z).

In one or more embodiments, generating the native print job ticket includes converting the user print job ticket by swapping the user print parameters and user values in the user print job ticket with the appropriate native print parameters and native values.

Those skilled in the art, having the benefit of this detailed description, will appreciate that as new print job ticket formats are added and/or as existing print job ticket formats are updated, there is no need to change the print manager software code. In one or more embodiments, only the number of print job dictionaries (114A-114C) and/or the content of the print job dictionaries (114A-114C) changes to reflect the new formats and/or updates to existing formats. This saves both time and expense.

Although FIG. 1 only shows a single user print job ticket (105), those skilled in the art, having the benefit of this detailed description, will appreciate that multiple user computing devices (102A-102C) may be issuing print job tickets in different formats, and that the print manager (110) generates a native print job ticket for each user print job ticket that is received.

In one or more embodiments of the invention, the user print job ticket (105) includes content (e.g., text, graphics, clipart, etc.) to be printed. In such scenarios, the content from the user print job ticket (105) may be included in the native print job format. Additionally or alternatively, the content to be printed is sent separately from the user print job ticket.

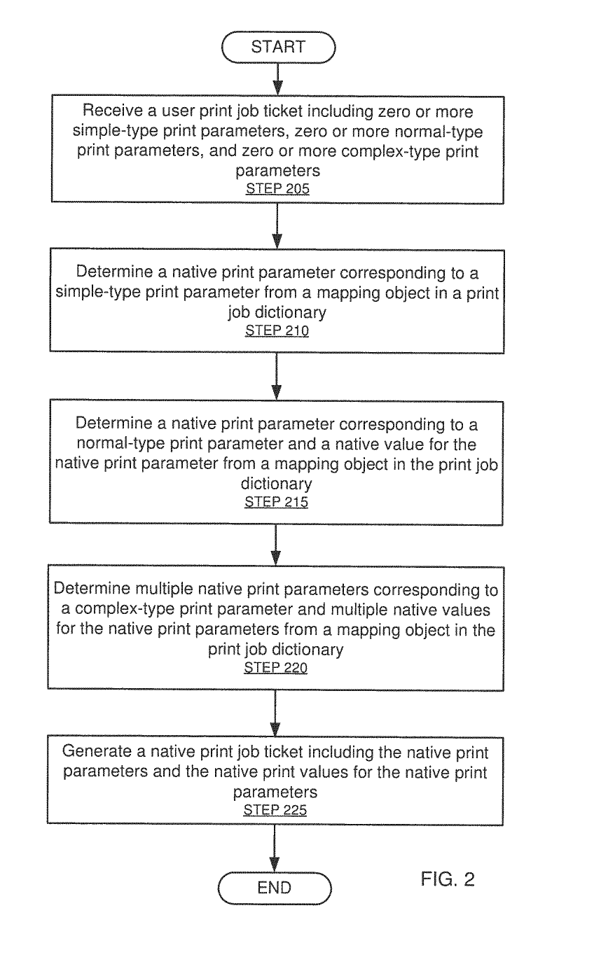

FIG. 2 shows a flowchart in accordance with one or more embodiments of the invention. The flowchart depicts a process for printing. One or more of the steps in FIG. 2 may be performed by the components of the system (100), discussed above in reference to FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Initially, a user print job ticket is received (STEP 205). The user print job ticket may be received from a user computing device. The user print job ticket may be downloaded from a server. The user print job ticket includes one or more user print parameters and user values for the user print parameters. The user print parameters and the user values form instructions for printing one or more print jobs (e.g., number of copies, stapling, two-sided printing, etc.). However, as the names of the user print parameters might be user-specific, printers might not be able to interpret/execute the instructions in the user print job ticket, and thus might not correctly print the one or more print jobs.

In one or more embodiments of the invention, each user print parameter may be classified as a simple-type print parameter, a normal-type print parameter, or a complex-type print parameter. The user print job ticket may have zero or more simple-type print parameters, zero or more normal-type print parameters, and zero or more complex-type print parameters (discussed above).

In STEP 210, a native print parameter is determined for a simple-type print parameter in the user print job ticket. This may include selecting a print job dictionary and then identifying, within the print job dictionary, a mapping object for the simple-type print parameter. The print job dictionary may be selected based on the source (e.g., user or user computing device) that issued the user print job ticket. The mapping object specifies the native print parameter that corresponds to the simple-type print parameter. Moreover, as this is a simple-type print parameter, the mapping object specifies that the native value for the native print parameter is equal to the user value, as specified in the user print job ticket, for the simple-type print parameter. STEP 210 may be repeated for each simple-type print parameter in the user print job ticket. However, subsequent iterations of STEP 210 might not need to select the print job dictionary as it has already been selected. STEP 210 might be omitted if the user print job ticket does not include any simple-type print parameters.

In STEP 215, a native print parameter is determined for a normal-type print parameter in the user print job ticket. This may include selecting a print job dictionary (if one has not yet been selected) and then identifying, within the print job dictionary, a mapping object for the normal-type print parameter. The print job dictionary may be selected based on the source (e.g., user or user computing device) that issued the user print job ticket. The mapping object specifies the native print parameter that corresponds to the normal-type print parameter. Also in STEP 215, a native value is determined for the native print parameter. The native value is based on the user value, as specified in the user print job ticket, for the normal-type print parameter. The mapping object also provides the mapping from the user value, specified in the user print job ticket, to the native value for the native print parameter. STEP 215 may be repeated for each normal-type print parameter in the user print job ticket. STEP 215 might be omitted if the user print job ticket does not include any normal-type print parameters.

In STEP 220, multiple native print parameters are determined for a complex-type print parameter in the user print job ticket. Additionally or alternatively, a single native print parameter may be determined for multiple complex-type print parameters. Additionally or alternative, multiple native print parameters may be determined for multiple complex-type print parameters. This may include selecting a print job dictionary (if one has not yet been selected) and then identifying, within the print job dictionary, a mapping object for the complex-type print parameter(s). The print job dictionary may be selected based on the source (e.g., user or user computing device) that issued the user print job ticket. For example, the mapping object specifies the multiple native print parameters that correspond to the complex-type print parameter. Also in STEP 220, a native value is determined for each of the native print parameters. Each native value is based on the user value, as specified in the user print job ticket, for the complex-type print parameter(s). The mapping object also provides the mapping from the user value, specified in the user print job ticket, to the native value for each of the multiple native print parameters. STEP 220 may be repeated for each complex-type print parameter in the user print job ticket. STEP 220 might be omitted if the user print job ticket does not include any complex-type print parameters.

In STEP 225 a native print job ticket is generated based on the user print job ticket. The native print job ticket includes the determined native print parameters and the determined native values for the native print parameters. However, the native print job ticket does not include the user print parameters. In one or more embodiments, the native print job ticket is generated by swapping the user print parameters and the user values in the user print job ticket with the determined native print parameters and native values. If the user print job ticket includes content (e.g., text, graphics, clipart, etc.) to be printed, the native print job ticket might also include the content. The native print job ticket may be sent to a printer. The printer may generate hardcopies based on the native print job ticket.

Those skilled in the art, having the benefit of this detailed description, will appreciate that the process depicted in FIG. 2 may be repeated for each user print job ticket that is received. Those skilled in the art, having the benefit of this detailed description, will also appreciate that the selected dictionary exists before the process shown in FIG. 2 is executed.

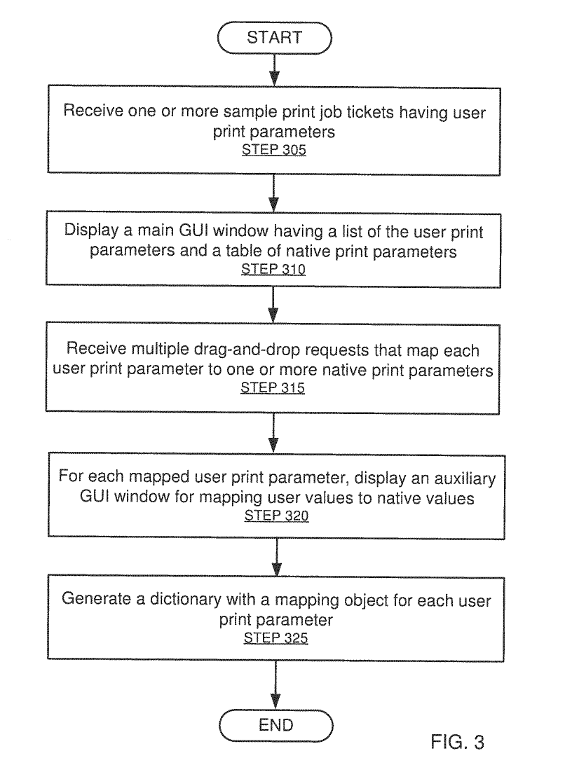

FIG. 3 shows a flowchart in accordance with one or more embodiments of the invention. The flowchart depicts a process for printing. Specifically, the flowchart depicts a process for generating a print job dictionary. One or more of the steps in FIG. 3 may be performed by the components of the system (100) (e.g., dictionary engine (112)), discussed above in reference to FIG. 1. The process depicted in FIG. 3 may be executed before the process in FIG. 2. In one or more embodiments of the invention, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3.

Initially, one or more sample print job tickets are received (STEP 305). The sample print job tickets may be received from a source (e.g., user or user computing device). Accordingly, the sample print job tickets are in a source-specific format. Each sample print job ticket includes one or more user print parameters. In one or more embodiments of the invention, the sample print job tickets may not be destined for a printer. Instead, the sample print job tickets may be only issued for the generation of a print job dictionary. In one or more embodiments, a print job dictionary may be created from an actual job ticket (i.e., not a sample print job ticket) destined for a printer.

In STEP 310, a main window GUI is displayed. The main window GUI may include a list with the user print parameters extracted from the sample print job ticket(s). The main window GUI may also include a table with at least some of the native print parameters.

In STEP 315, multiple drag and drop requests are received. Specifically, an operator may drag a user print parameter from the list and drop it in the table next to the corresponding native print parameter. If the user print parameter corresponds to multiple native print parameters (e.g., the user print parameter is a complex-type print parameter), the operator may drop the user print parameter next to one of the corresponding native print parameters, and then augment the table (discussed below) to include the additional corresponding native print parameters adjacent to the dropped user print parameter. It is through these drag-drop and augment operations that the table is populated and that relationships (e.g., mappings) between each user print parameter and one or more corresponding native print parameters are formed.

In one or more embodiments, tables and/or print job dictionaries can be imported, exported, shared, etc. In other words, in one or more embodiments, the operator may import a partially populated table to avoid populating the entire table. This is especially useful if only a small number of entries in the table are being modified (e.g., due to an update to an existing print job ticket format).

In STEP 320, an auxiliary GUI window is displayed for each mapped user print parameter. Specifically, the auxiliary GUI window enables the operator to specify the mappings between a user value for a user print parameter and a native value for the corresponding native print parameter. As discussed above, a user print parameter may be classified as a simple-type print parameter, a normal-type print parameter, and a complex-type print parameter. In a simple-type print parameter, the native value (for the native print parameter) equals the user value. In normal-type or complex-type print parameters, the native value (for the native print parameter) is usually different from the user value.

In STEP 325, a print job dictionary is generated. The print job dictionary includes a mapping object for each user print parameter. The mapping object for the user print parameter specifies the one or more native print parameters that correspond to the user print parameter, as established by the populated table. The mapping object also sets forth the mappings between the user value (for the user print parameter) and the native value (for the native print parameter), as set forth by the operator in the auxiliary GUI windows.

Those skilled in the art, having the benefit of this detailed description, will appreciate that an updated print job dictionary may be generated by updating the table and/or updating the mappings between a user value and a native value. In other words, STEP 325 may be re-executed each time there is an update to a table or to a mapping between a user value and a native value.

Those skilled in the art, having the benefit of this detailed description, will also appreciate that the process in FIG. 3 may be repeated for each source of user print job tickets. Accordingly, after executing the process in FIG. 3 multiple times, multiple print job dictionaries may exist.

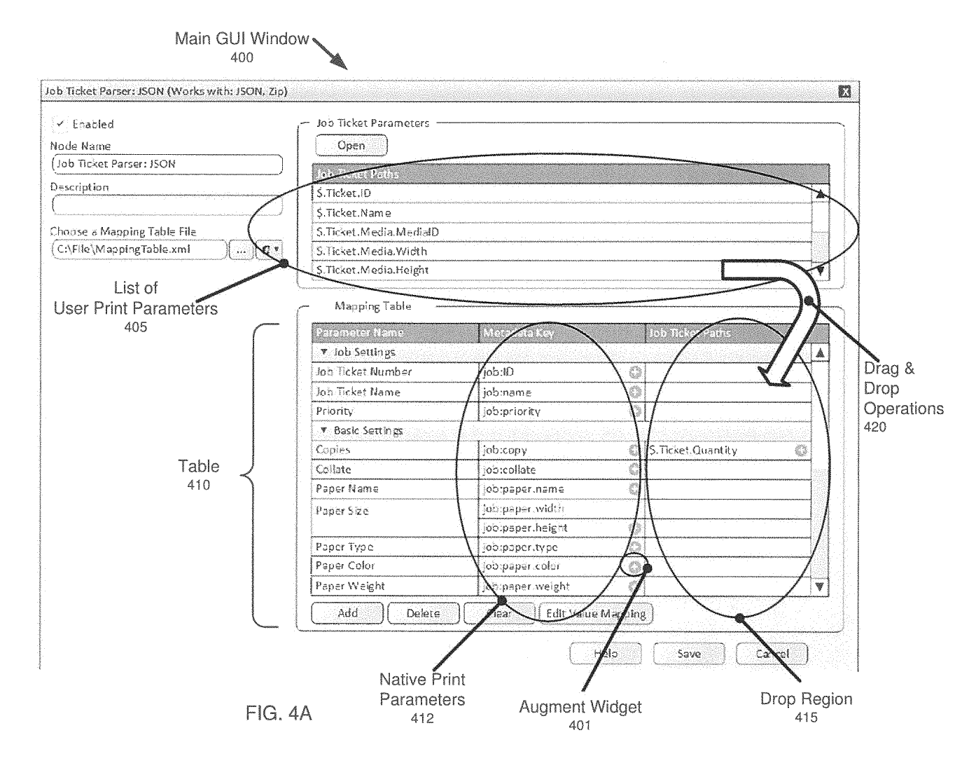

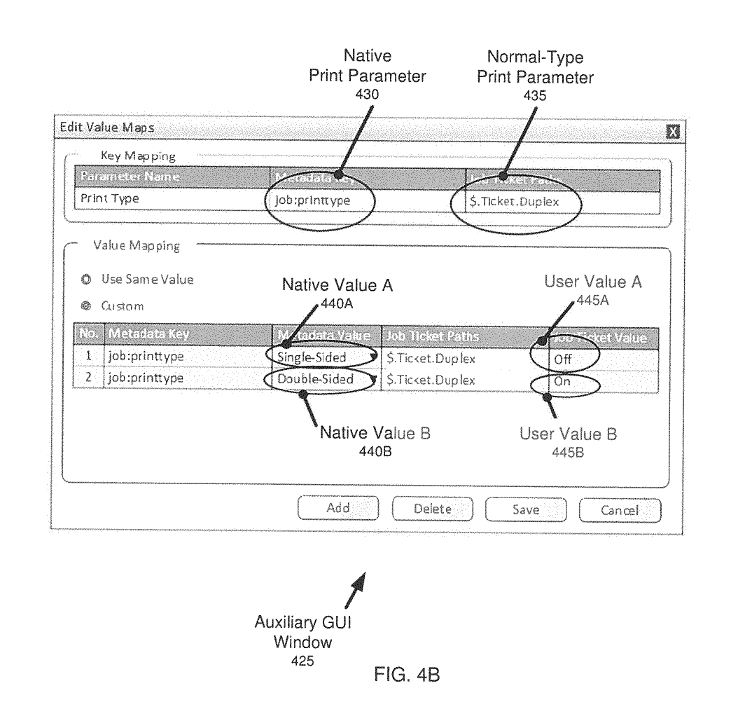

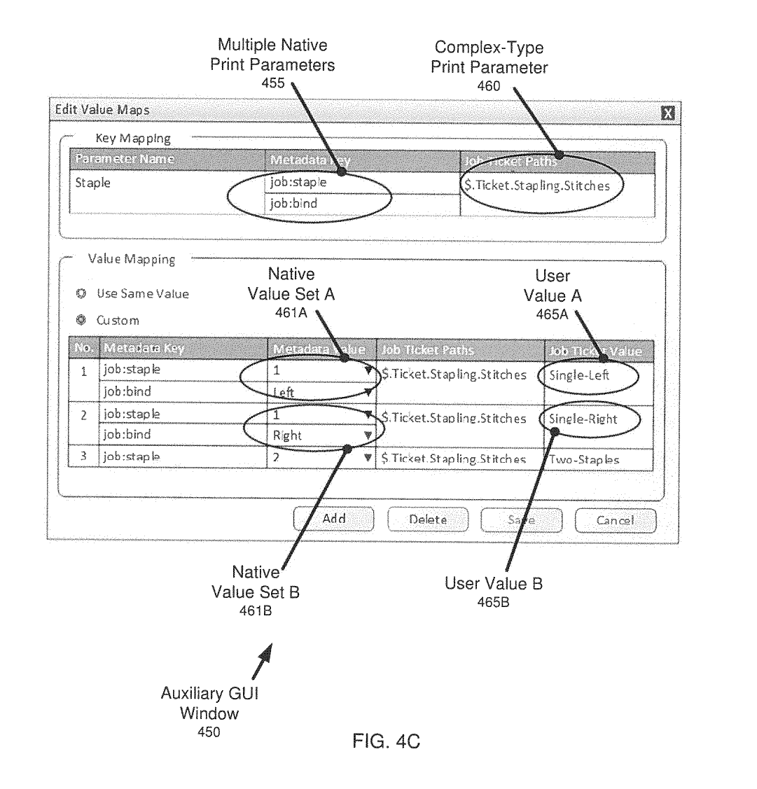

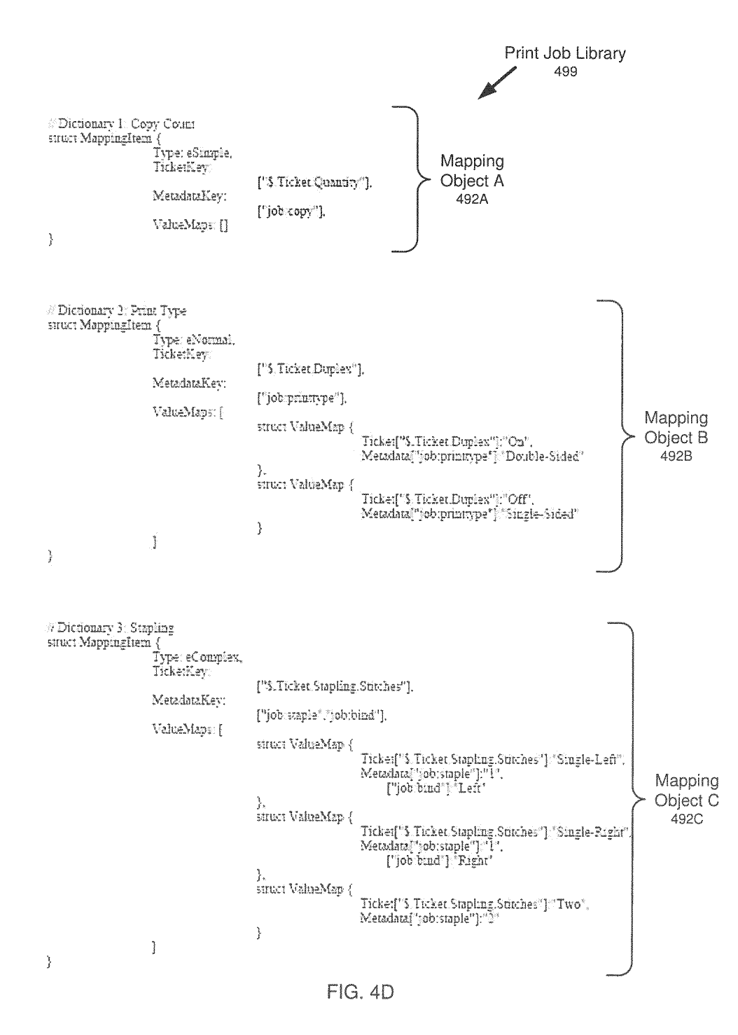

FIGS. 4A and 4B show examples in accordance with one or more embodiments of the invention. Specifically, FIG. 4A shows a main GUI window (400) in accordance with one or more embodiments of the invention. The main GUI window (400) includes a list of user print parameters (405) and a table (410) with native print parameters (412). The user print parameters in the list (405) have been extracted from one or more sample print job tickets.

The table (410) also includes a drop region (415). Specifically, an operator may drag a user print parameter from the list (405) and drop it in the table (410) (i.e., within drop region (415)) next to the corresponding native print parameter (412). If the user print parameter corresponds to multiple native print parameters (e.g., native print parameter A, native print parameter B), the operator may drop the user print parameter next to one of the corresponding native print parameters (e.g., native print parameter A), and then augment the table (410) to include the additional corresponding native print parameters (e.g., native print parameter B) adjacent to the dropped user print parameter. The table (410) may be augmented by selecting an augment widget (401) next to native print parameter A. This effectively adds a row immediately below native print parameter A that can be populated with native print parameter B.

It is through these drag-drop operations (420) that the table (410) is populated and that relationships (e.g., mappings) between each user print parameter and one or more corresponding native print parameters are formed.

FIG. 4B shows an auxiliary GUI window (425) for a normal-type print parameter. The auxiliary GUI window enables an operator to map the user value (for a user print parameter) to a native value (for the corresponding native print parameter). In FIG. 4B, the normal-type print parameter (435) is “$.Ticket.Duplex” and the corresponding native print parameter (430) is “job:printtype.” Both “$.Ticket.Duplex” and “job:printtype” are print parameters corresponding to two-sided printing. As shown in FIG. 4B, if the normal-type print parameter (435) takes on user value A (445A), then the native print parameter (430) must take on native value A (440A). Similarly, if the normal-type print parameter (435) takes on user value B (445B), then the native print parameter (430) must take on native value B (440B).

FIG. 4C shows another auxiliary GUI window (450), but for a complex-type print parameter. The auxiliary GUI window (450) enables an operator to map the user value (for a user print parameter) to a native value (for the corresponding native print parameters). In FIG. 4C, the complex-type print parameter (460) is “$.Ticket.Stapling.Stitches” and the corresponding multiple native print parameters (455) are “job:staple” and “job:bind.” All of “$.Ticket.Stapling.Stiches,” “job:staple,” and “job:bind” are print parameters corresponding to stapling. As shown in FIG. 4C, if the complex-type print parameter (460) takes on user value A (465A), then the multiple native print parameters (455) must take on native value set A (461A). Similarly, if the complex-type print parameter (460) takes on user value B (465B), then the multiple native print parameters (455) must take on native value set B (461B).

FIG. 4D shows a print job library (499) in accordance with one or more embodiments of the invention. The print job library (499) includes multiple mapping objects (e.g., Mapping Object A (492A), Mapping Object B (492B), Mapping Object C (492C)). Mapping Object B (492B) corresponds to the normal-type print parameter and native print parameter discussed above in reference to FIG. 4B. Mapping Object C (492C) corresponds to the complex-type print parameter and multiple native print parameters discussed above in reference to FIG. 4C.

Various embodiments of the invention may have one or more of the following advantages: the ability to generate a native print job ticket that can be interpreted/executed by a printer based on a user print job ticket that cannot be interpreted/executed by the printer; the ability to map a user print parameter to one or more native print parameters using a table; the ability to populate the table (and thus create the mappings) using drag-and-drop operations; the ability to classify each user print parameter as a simple-type print parameter, a normal-type print parameter, and a complex-type print parameter; the ability to map user values to native values; the ability to use dictionaries with mapping objects and thus avoid modifying print manager software code when new print job ticket formats exists or when existing print job ticket formats are updated; the ability to update a dictionary by updating a table; etc.

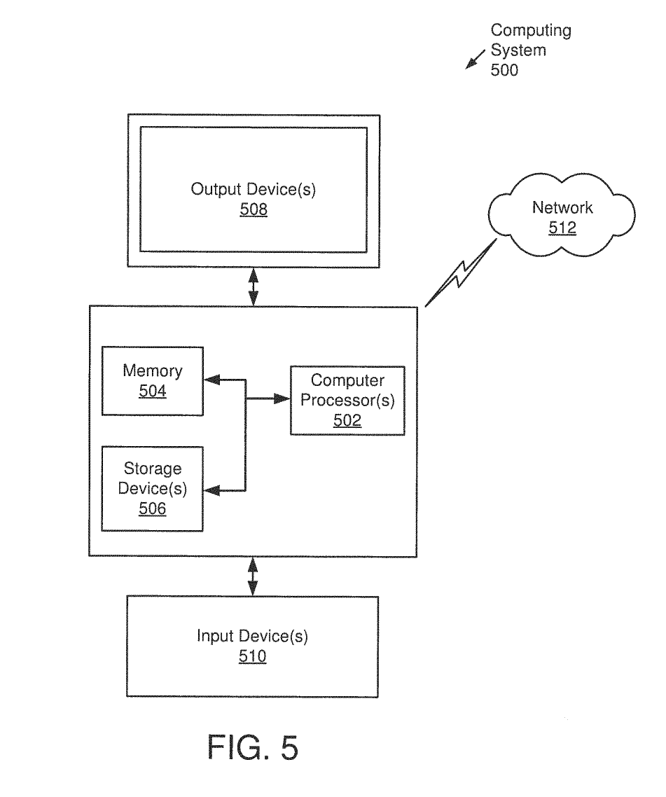

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (500) may include one or more computer processor(s) (502), associated memory (504) (e.g., random access memory (RAM), cache memory, flash memory, etc.), one or more storage device(s) (506) (e.g., a hard disk, an optical drive such as a compact disk (CD) drive or digital versatile disk (DVD) drive, a flash memory stick, etc.), and numerous other elements and functionalities. The computer processor(s) (502) may be an integrated circuit for processing instructions. For example, the computer processor(s) may be one or more cores, or micro-cores of a processor. The computing system (500) may also include one or more input device(s) (510), such as a touchscreen, keyboard, mouse, microphone, touchpad, electronic pen, or any other type of input device. Further, the computing system (500) may include one or more output device(s) (508), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (500) may be connected to a network (512) (e.g., a local area network (LAN), a wide area network (WAN) such as the Internet, mobile network, or any other type of network) via a network interface connection (not shown). The input and output device(s) may be locally or remotely (e.g., via the network (512)) connected to the computer processor(s) (502), memory (504), and storage device(s) (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (500) may be located at a remote location and connected to the other elements over a network (512). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for printing, comprising:
receiving, by a print manager executing on a computer processor, a user print job ticket comprising a normal-type print parameter and a first user value for the normal-type print parameter,
identifying, within a print job dictionary, a first mapping object for the normal-type print parameter;
determining, by the print manager and from the first mapping object, a first native print parameter corresponding to the normal-type print parameter;
determining, by the print manager and from the first mapping object, a first native value corresponding to the first user value;
generating, by the print manager, a native print job ticket comprising the first native print parameter and the first native value for the first native print parameter; and
printing, by a printer, a hardcopy based on the native print job ticket by sending the native print job ticket to the printer.

2. The method of claim 1, wherein the normal-type print parameter corresponds to two-sided printing.

3. The method of claim 1, further comprising:
identifying, within the print job dictionary, a second mapping object for a complex-type print parameter in the user print job ticket,
wherein the user print job ticket further comprises a second user value for the complex-type print parameter;
determining, by the print manager and from the second mapping object, a plurality of native print parameters corresponding to the complex-type print parameter; and
determining, by the print manager and from the second mapping object, a plurality of native values corresponding to the second user value,
wherein the native print job ticket further comprises the plurality of native print parameters and the plurality of native values for the plurality of native print parameters.

4. The method of claim 3, wherein the complex-type print parameter corresponds to stapling.

5. The method of claim 1, further comprising:
identifying, within the print job dictionary, a second mapping object for a simple-type print parameter in the user print job ticket,
wherein the user print job ticket further comprises a second user value for the simple-type print parameter, and
determining, by the print manager and from the second mapping object, a second native print parameter corresponding to the simple-type print parameter; and
determining, by the print manager and from the second mapping object, the second user value is also for the second native print parameter,
wherein the native print job ticket further comprises the second native print parameter and the second user value for the second native print parameter.

6. The method of claim 1, wherein the simple-type print parameter corresponds to a number of copies.

7. The method of claim 1, further comprising:
obtaining a sample print job ticket from the user and comprising a plurality of user print parameters;
displaying a main graphical user interface (GUI) window comprising:
a list comprising the plurality of user print parameters; and
a table comprising a plurality of native print parameters;
receiving a plurality of drag-and-drop requests to populate the table and map the plurality of user print parameters to the plurality of native print parameters; and
generating the print job dictionary based on the table.

8. The method of claim 7, further comprising:
displaying an auxiliary GUI window corresponding to the normal-type print parameter and the first native print parameter; and
receiving, from an operator, a mapping from the first user value to the first native value,
wherein the print job dictionary is further generated based on the mapping.

9. The method of claim 1, further comprising:
selecting the printer from a plurality of printers, wherein each of the plurality of printers is configured to process the native print job ticket.

10. A system for printing, comprising:
a memory;
a computer processor that:
receives a user print job ticket and comprising a normal-type print parameter and a first user value for the normal-type print parameter,
identifies, within a print job dictionary, a first mapping object for the normal-type print parameter;
determines, from the first mapping object, a first native print parameter corresponding to the normal-type print parameter;
determines, from the first mapping object, a first native value corresponding to the first user value; and
prints, from a printer, a native print job ticket comprising the first native print parameter and the first native value for the first native print parameter; and
the printer that generates a hardcopy based on the native print job ticket.

11. The system of claim 10, wherein the computer processor also:
identifies, within the print job dictionary, a second mapping object for a complex-type print parameter in the user print job ticket,
wherein the user print job ticket further comprises a second user value for the complex-type print parameter,
determines, from the second mapping object, a plurality of native print parameters corresponding to the complex-type print parameter; and
determines, from the second mapping object, a plurality of native values corresponding to the second user value,
wherein the native print job ticket further comprises the plurality of native print parameters and the plurality of native values for the plurality of native print parameters.

12. The system of claim 10, wherein the computer processor also:
identifies, within the print job dictionary, a second mapping object for a simple-type print parameter in the user print job ticket,
wherein the user print job ticket further comprises a second user value for the simple-type print parameter; and
determines, from the second mapping object, a second native print parameter corresponding to the simple-type print parameter; and
determines, from the second mapping object, the second user value is also for the second native print parameter,
wherein the native print job ticket further comprises the second native print parameter and the second user value for the second native print parameter.

13. The system of claim 10, wherein the computer processor also:
obtains a sample print job ticket from the user and comprising a plurality of user print parameters;
displays a main graphical user interface (GUI) window comprising:
a list comprising the plurality of user print parameters; and
a table comprising a plurality of native print parameters;
receives a plurality of drag-and-drop requests to populate the table and map the plurality of user print parameters to the plurality of native print parameters; and
generates the print job dictionary based on the table.

14. The system of claim 13, wherein the computer processor also:
displays an auxiliary GUI window corresponding to the normal-type print parameter and the first native print parameter; and
receives, from an operator a mapping from the first user value to the first native value,
wherein the print job dictionary is further generated based on the mapping.

15. A non-transitory computer readable medium (CRM) storing computer program code executed by a computer processor that:
receives a user print job ticket and comprising a normal-type print parameter and a first user value for the normal-type print parameter,
identifies, within a print job dictionary, a first mapping object for the normal-type print parameter;
determines, from the first mapping object, a first native print parameter corresponding to the normal-type print parameter;
determines, from the first mapping object, a first native value corresponding to the first user value;
generates a native print job ticket comprising the first native print parameter and the first native value for the first native print parameter; and
prints, by a printer, a hardcopy based on native print job ticket by sending the native print job ticket to the printer.

16. The non-transitory CRM of claim 15, wherein the computer program code executed by the computer processor also:
identifies, within the print job dictionary, a second mapping object for a complex-type print parameter in the user print job ticket,
wherein the user print job ticket further comprises a second user value for the complex-type print parameter;
determines, from the second mapping object, a plurality of native print parameters corresponding to the complex-type print parameter; and
determines, from the second mapping object, a plurality of native values corresponding to the second user value,
wherein the native print job ticket further comprises the plurality of native print parameters and the plurality of native values for the plurality of native print parameters.

17. The non-transitory CRM of claim 15, wherein the computer program code executed by the computer processor also:
identifies, within the print job dictionary, a second mapping object for a simple-type print parameter in the user print job ticket,
wherein the user print job ticket further comprises a second user value for the simple-type print parameter, and
determines, from the second mapping object, a second native print parameter corresponding to the simple-type print parameter;
determines, from the second mapping object, the second user value is also for the second native print parameter,
wherein the native print job ticket further comprises the second native print parameter and the second user value for the second native print parameter.

18. The non-transitory CRM of claim 15, wherein the computer program code executed by the computer processor also:
obtains a sample print job ticket from the user and comprising a plurality of user print parameters;
displays a main graphical user interface (GUI) window comprising:
a list comprising the plurality of user print parameters; and
a table comprising a plurality of native print parameters;
receives a plurality of drag-and-drop requests to populate the table and map the plurality of user print parameters to the plurality of native print parameters; and
generates the print job dictionary based on the table.

19. The non-transitory CRM of claim 18, wherein the computer program code executed by the computer processor also:
displays an auxiliary GUI window corresponding to the normal-type print parameter and the first native print parameter; and
receives, from an operator, a mapping from the first user value to the first native value,
wherein the print job dictionary is further generated based on the mapping.

20. The non-transitory CRM of claim 18, wherein the computer program code executed by the computer processor also selects the printer from a plurality of printers, wherein each of the plurality of printers is configured to process the native print job ticket.
